(19) United States
(12) Patent Application Publication
(10) Pub. No.: US 2018/0356117 A1
(43) Pub. Date: Dec. 13, 2018

(54) HVAC Duct System, Method and Machine

(71) Applicant: Fran Lanciaux, Grand Rapids, OH (US)

(72) Inventor: Fran Lanciaux, Grand Rapids, OH (US)

(21) Appl. No.: 16/006,770

(22) Filed: Jun. 12, 2018

Related U.S. Application Data
(60) Provisional application No. 62/518,175, filed on Jun. 12, 2017.

(51) Int. Cl. F24F 13/02; F16L 13/10; F16L 59/14; B29C 65/56; B29C 65/00

(52) U.S. Cl. CPC F24F 13/0245; F16L 13/103; F16L 59/143; B29K 2701/12; B29C 66/1312; B29C 66/5221; B29C 65/562

(57) ABSTRACT

A method for connecting two duct sections having an outer layer of thermoplastic material and an inner layer of foam, and duct produced by the method. The method entails the use of thermoplastic material to form at least one flange in the finished duct. The thermoplastic material may be a portion of the outer thermoplastic layer of the duct section or it may be made, in-situ, from a separate strip or strips of thermoplastic material. In the latter case, a strip of thermoplastic material may be fashioned into a sleeve in which the ends of the duct sections reside or a separate strip may be securely fastened to each of the ends of each of the duct sections. In the latter case, a portion of the strip extends radially outwardly and a belly band or the like is positioned over the radially outwardly extending portion of the strip and tightened to bring them together and seal the interface between the ends of the duct sections.

### FIELD OF THE INVENTION

This invention relates to the field of ducts for use in heating, ventilating, and air conditioning systems.

### BACKGROUND OF THE INVENTION

There is a need for an improved duct system and, especially, an improved outdoor duct system. Outdoor ductwork presents unique problems for the design and engineering community. It consumes energy. In some cases, outdoor ductwork can be, or become, a health risk. Many current technologies for producing outdoor ducting do not produce a duct that is 100% water tight so moisture can penetrate into the duct thereby reducing the thermal resistance of the duct insulation and, in some cases, even promoting growth of bacteria and mold inside the duct itself.

The clad duct disclosed in my U.S. Pat. Nos. 9,840,050, 9,840,051, and 9,114,579, is available commercially under the mark ThermaDuct, and it represents a dramatic improvement over prior clad duct systems. ThermaDuct employs a heavy vinyl barrier that can be cohesively (chemically) or thermally welded to make it virtually water tight. Challenges remained though in regard to coupling individual duct sections to each other and in regard to providing a duct capable of standing up to excessive weight from accumulated snow loads encountered in northern climates.

Duct according to the present invention has a generally cylindrical or oval shape, in cross-section. Duct sections are produced from duct board and they are easily and securely connected together by a new coupling system that makes the duct more air and water tight than was heretofore possible. Further details about the duct sections, ducts made from the duct sections and methods for fabricating and coupling duct sections will be gleaned from the following detailed description.

The following patents have been cited in connection the examination of my prior patent applications directed to ducts: U.S. Pat. Nos. 1,916,908, 1,959,426, 2,493,439, 2,275,572, 2,916,054, 3,202,184, 3,212,529, 3,080,910, 3,259,030, 3,557,838, 3,557,840, 3,588,059, 3,787,158, 3,832,956, 4,139,051, 4,249,578, 4,287,245, 4,315,361, 4,581,965, 4,605,043, 4,983,081, 5,141,212, 5,219,403, 5,226,557, 5,310,594, 5,549,942, 5,626,982, 5,783,268, 5,918,644, 5,944,060, 5,971,034, 6,000,437, 6,059,494, 6,298,555, 6,231,704, 6,311,735, 6,360,783, 6,664,549, 6,716,520, 6,717,520, 6,763,853, 6,872,673, 6,901,969, 7,035,707, 7,069,957, 7,140,396, 7,185,412, 7,624,762, 7,712,787, 8,667,995, 8,950,439, 9,840,050, and RE31053. The following published US patent applications have been cited in connection the examination of my prior patent applications directed to ducts: 20030213525, 20060083889, 20060206233, 20070026179, 20100071797, 20110030833, and 20130074974.

### SUMMARY OF THE INVENTION

Clad foam duct sections are provided with at least one flange which is used to connect adjacent ones of them to produce a duct according to the invention.

In one embodiment, a laminate is formed by bonding a sheet of foam material to a sheet of thermoplastic material and the laminate is manipulated into a generally cylindrical or oval duct preform configuration with a portion of the thermoplastic sheet extending beyond the end of the foam sheet to create an overhanging, longitudinally extending flange. Heat is applied to the overhanging flange portion of the thermoplastic sheet and it is manipulated so that becomes a flange extending radially outwardly from the end of the duct preform. A second corresponding duct preform is produced and the flanges are brought together in face to face contact. An internal coupling may be positioned inside of the duct preform. A belly band is then applied to the two duct preform sections and, specifically, to the flanges to secure them together and to maintain the flanges in face to face contact.

In another embodiment, a longitudinally extending flange may be provided at the end of a duct section to capture and engage the end of an adjacent duct section, thereby connecting the two duct sections. The flange is joined securely to a portion of the end of the duct section especially, for example, by means of an adhesive substance, sonic welding, heat, and/or pressure. The flange extends longitudinally beyond the end of the duct section and is sized to receive a portion of the end of an adjacent duct section to which it is then securely joined. The flange may be formed from a strip of thermoplastic material such as vinyl or the like. The strip of material may have a length which is less than the length of the outer circumference of the end of a given duct section. The strip may be rendered pliable, by the application of heat, and then wrapped around one or both of the end portions of two adjacent ducts so that it spans the interface between them or, if wrapped around only one duct section, initially, it projects longitudinally beyond the end portion of that duct section. In the latter case, the interior diameter of the extending portion of the strip is sized so that the end portion of an adjacent duct may be received therein. During the wrapping step, if the strip has a length which is less than the length of the outer circumference of the end of the duct section, the length of the strip may be increased by manipulation of the softened thermoplastic material until it matches precisely the length of the outer circumference of the end of the duct section. Upon cooling, the strip will maintain the shape and length obtained by the manipulation thereof. Again, the flange formed by the strip is, ultimately, joined securely to the end portions of the adjacent ducts providing excellent strength in the joint between the two adjacent duct sections as well as an excellent seal.

In another embodiment, two lengths of strip material are used to produce two flanges, one of which is secured to the end portion of a first duct section and the other one of which is secured to the end portion of a second duct section. The strip material is angled so that, when it is heated and manipulated and securely joined to the end portion of one of the duct sections to form a flange, a first portion of the flange encircles the end portion of the duct section and a second rib portion of the flange extends radially outwardly from the first portion of the flange and the end of the duct section. The second rib portion of the flange may be secured to the end portion of the duct so that the second rib portion is flush with the end face of the end portion of the duct. Rib portions of two duct preforms are secured together as by a belly band, for example, to maintain the flanges in face to face contact.

### BRIEF DESCRIPTION OF THE DRAWINGS

FIG. 1 is a cross-sectional view of the components of a laminate board suitable for use in making duct section pre-forms according to the invention.

FIG. 2 is a cross-sectional view of laminate board.

FIG. 3a is an upper right perspective view of a portion of duct board made from the laminate board shown in FIG. 2.

FIG. 3b is a perspective view of a duct section pre-form.

FIG. 4a is a cross-sectional view of duct board.

FIG. 4b is a cross-sectional view of duct board.

FIG. 5 is a cross-sectional view of flanged duct section pre-form.

FIG. 6 is a cross sectional view showing a step in connecting two flanged duct section pre-forms.

FIG. 7 is a cross sectional view showing a step in connecting two flanged duct section pre-forms.

FIG. 8 is a cross sectional view showing a step in connecting two flanged duct section pre-forms.

FIG. 9 is a cross sectional view showing a step in connecting two flanged duct section pre-forms.

FIG. 10 is a cross sectional view showing two flanged duct section pre-forms connected to each other.

FIG. 11 is a cross-sectional view of a gasket support band.

FIG. 12 is a cross-sectional view of a belly band.

FIG. 13 is a perspective view of a belly band.

FIG. 14 is a cross sectional view of end portions of duct sections showing another embodiment of a duct connector for connecting duct sections.

FIG. 15 is a cross sectional view of end portions of duct sections showing yet another embodiment of a duct connector for connecting duct sections.

### DETAILED DESCRIPTION OF THE INVENTION

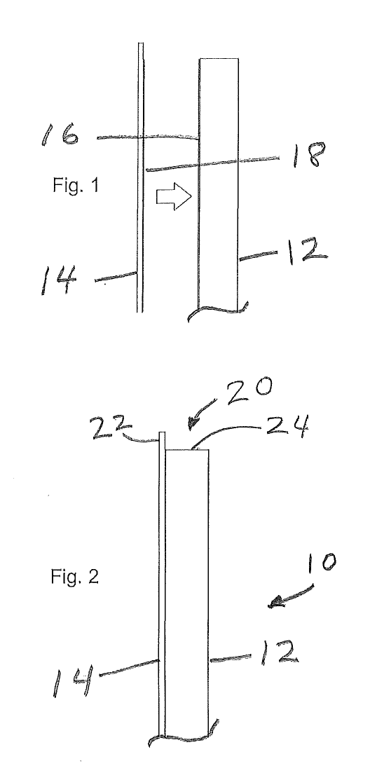

Referring now to FIGS. 1 and 2, duct board according to the present invention is indicated generally at 10. The duct board 10 is a laminate comprising more than one material. The board 10 comprises a layer of foam insulation panel 12 and a sheet of thermoplastic polymer 14. The sheet 14 is inflexible or rigid at or near room temperature. Good results have been obtained where the sheet 14 is composed of a vinyl material such as PVC. The composition of the sheet 14 is such that it may be rendered flexible when heated so that it can be manipulated to have a different shape and, when cooled, it will maintain the shape that it had after it was manipulated. The sheet 14 may have any one of a range of thicknesses. For example, a range of 0.3 mm to 2.0 mm is suitable. A preferred thickness range is 0.6 mm to 1.7 mm. A thickness of substantially 1.0 mm is especially preferred for use with the foam panels specifically disclosed and described herein.

The foam panel 12 may be faced with facing sheets (not shown). The facing material may be scrimmed aluminum foil or any other acceptable facing material. Excellent results have been obtained where the foam insulation panel 12 is one that is available from Kingspan under the trademark KoolDuct®. It is a rigid phenolic insulation panel that has a rigid phenolic insulation core with zero Ozone Depletion Potential (ODP), autohesively bonded on both sides to a 1 mil low vapor permeability aluminum foil facing reinforced with a 0.2″ glass scrim. KoolDuct rigid phenolic insulation panels are available in thicknesses of ⅞″, 1 3/16″ and 1 5/16″. KoolDuct panels are approximately four feet wide and come in lengths of ten feet and thirteen feet. It has a high R value, excellent fire and heat resistance properties, and it is a closed cell foam. KoolDuct is distributed with foil facing layers.

As mentioned above, the sheet 14 is made from a thermoplastic material and good results have been obtained using PVC thermoplastic sheet material. In a finished duct, the sheet 14 will be on the outside and so the material should be selected for this type of service. It is preferred that it contain additives to prolong its service life. For example, lithium oxide may be added to improve resistance to degradation caused by ultraviolet radiation. The sheet 14 is securely bonded to the foam insulation panel. Excellent results have been obtained with polyurethane adhesive systems. In any case, a strong and secure bond is required between the panel 12 and the sheet 14. In the case of an adhesive, a layer of an adhesive indicated at 16 can be applied to the panel 12 or a layer of adhesive 18 can be applied to the sheet 14, or both, and the panel 12 and the sheet 14 are pressed together until they are adhesively bonded into the laminate 10. Sonic and thermal means, among others, may also be used to cohesively bond the panel 12 and the sheet 14 together.

At a first end 20 of the laminate 10, an overhanging portion 22 of the sheet 14 extends beyond a first end 24 of the panel 12. At the other end (not shown) of the laminate 10, the sheet 14 may extend beyond the other end of the panel 12. This is preferred. In any case, the sheet 14 is, by design, longer than the foam panel 12 and thus an overhanging portion 22 of sheet 14 is created when the sheet 14 and the foam panel 12 are laminated together. For example, the foam panel 12 might be 47″ long and the vinyl cladding might be 48″ long. In this case, the sheet 14 and the panel 12 may be bonded together so that there is an overhanging portion 22 of the sheet 14 that extends 0.5″ beyond the end 24 of the panel 12, and a corresponding overhanging portion (not shown) of the sheet 14 that extends 0.5″ extend from a second opposed end of the panel 12.

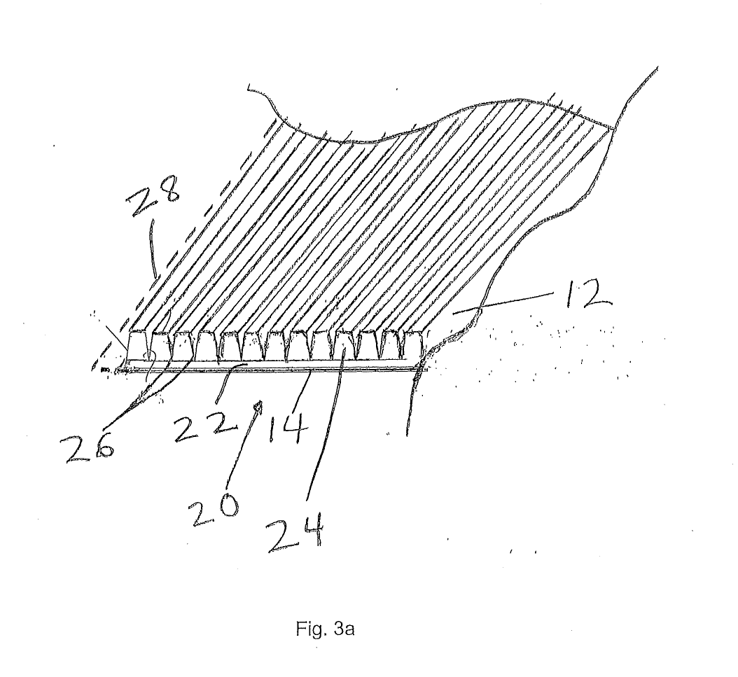

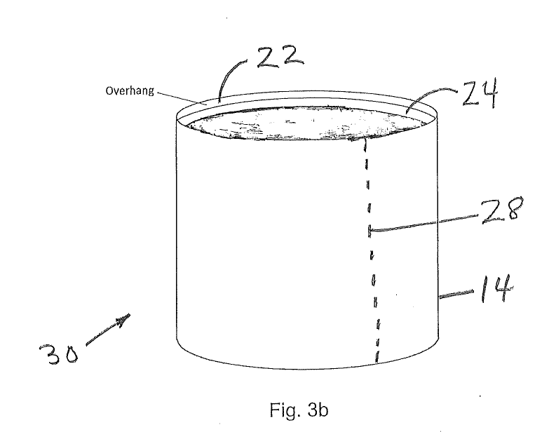

Referring now to FIG. 3a, generally parallel, longitudinally extending grooves 26 are provided in the foam panel 12 and the grooves 26 extend down to, but not through, the sheet 14. The grooves 26 are tapered so that they are narrower adjacent to the sheet 14 and wider at the surface of the panel 12 that is opposite the sheet 14.

HVAC ducts vary drastically in size. Generally speaking, in a large duct, the number of grooves will be larger than the number of grooves in a relatively smaller duct. Generally speaking, for a duct having a diameter up to 12″, 15 grooves are preferred. For a duct having a diameter of 14″ to 28″, 31 grooves are preferred. For a duct having a diameter of 30″ to 40″, 39 grooves are preferred. For a duct having a diameter of 42″ to 80″, 63 grooves are preferred. For a duct having a diameter of greater than 80″, 79 grooves are preferred.

The overhanging portion 22 of the sheet 14 projects longitudinally from and beyond the first end 24 of the panel 12. As explained below, this overhanging portion 22 is part of a system and a method for producing duct and for joining duct sections together. In one embodiment, an overhanging portion 28 (shown in dashed lines) of the sheet 14 may extend from and beyond the side of the panel 12, as shown in dashed lines. The extension 28 may be used to connect and join one side of the laminate 10 to the other side of the laminate 10 when the laminate is formed into a duct section as by rolling, as described below.

A duct section pre-form indicated generally at 30 in FIG. 3b is formed by rolling the laminate 10 shown in FIG. 3a and joining or connecting the sides of the laminate 10 together. In a case where the laminate 10 includes an overhanging portion 28 extending from one side of the laminate 10, the overhanging portion 28 may be positioned so that it overlaps the sheet 14 on the other side of the sheet 14, i.e., the side that is opposite the side with the overhanging portion 28. The overlapping portion of the extension 28 is secured or bonded to the sheet 14 as by adhesive or other suitable means. In a case where there is no extension 28, a strip of material (not shown) may be used to connect the sides of the laminate where the edges of the sides of the sheet 14 come together. The strip of material can be secured or bonded to the sheet 14, after the laminate is rolled into a cylindrical shape, so that it overlaps the seam formed between the edges of the sides of the sheet 14. The strip of material may be bonded to the sheet 14 as by adhesive or other suitable means. Alternatively, but not exclusively, the edges at the sides of the sheet 14 may be secured together as by welding.

Depending on the size of the laminate sheet and the number of grooves in the foam panel 12, the laminate may or may not require heating in order to roll it into a cylindrical shape.

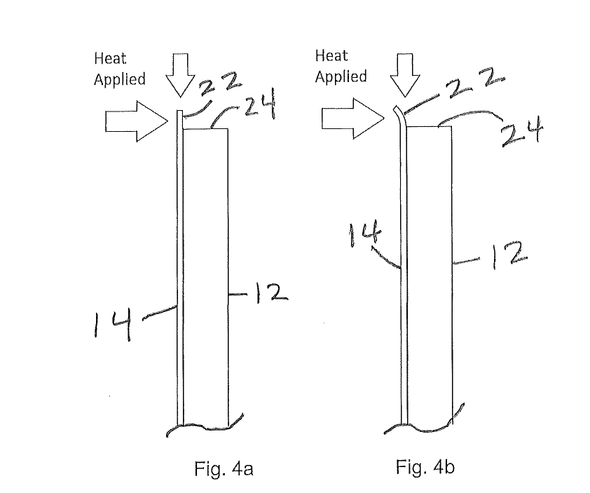

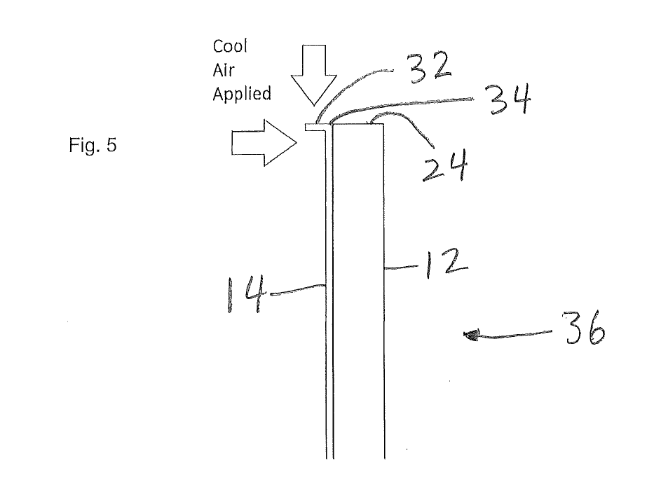

In the duct section pre-form 30, the overhanging portion 22 at one end of the sheet 14 has taken on the shape of a circumferentially extending band. A corresponding band shaped extension may be provided at the other end of the duct section 30, as described above. At this stage in a method for producing a duct section according to the invention, the extension or overhang 22 extends in a longitudinal direction relative to the duct section 30. Next, the extension 22 is transformed from a longitudinally extending band or cylinder shape to a radially extending flange 32. One method for forming the extension 22 into a radially extending flange 32 is illustrated in FIGS. 4a, 4b and 5. These Figs. show longitudinal cross sections of the duct section pre-form 30.

The formation of a radially extending flange 32 out of the overhanging portion 22 begins with the application of heat to the overhanging portion 22, as indicated in FIG. 4a, to render it pliable. When the overhanging portion 22 is heated enough to be pliable, it is manipulated radially outwardly, as shown in FIG. 4b, into the shape shown in FIG. 5, i.e., a radially extending flange 32. While the overhanging portion 22 is maintained in this configuration or shape, it is cooled and it is cooled to the extent that it maintains the shape shown in FIG. 5.

As shown in FIG. 5, the radially extending flange 32 and the end 24 of the foam panel 12 are in the same plane. In other words, the radially extending flange 32 has a bend 34 located right at the end 24 of the foam panel 12. The resulting structure is the flanged duct section pre-form 36 shown in FIG. 5.

It will be appreciated that the bend 34 in the flange 32 can be longitudinally offset from the end 24 of the foam panel. For example, the end 24 of the foam panel 12 might be recessed relative to the bend 34, at one end of the flanged duct section pre-form 36 and, at the other end, the foam panel 12 might project beyond the bend 34. When two such duct sections are joined, a portion of the foam panel 12 of one duct section preform can be received within a cylindrical portion of the sheet 12 of the adjacent duct section preform.

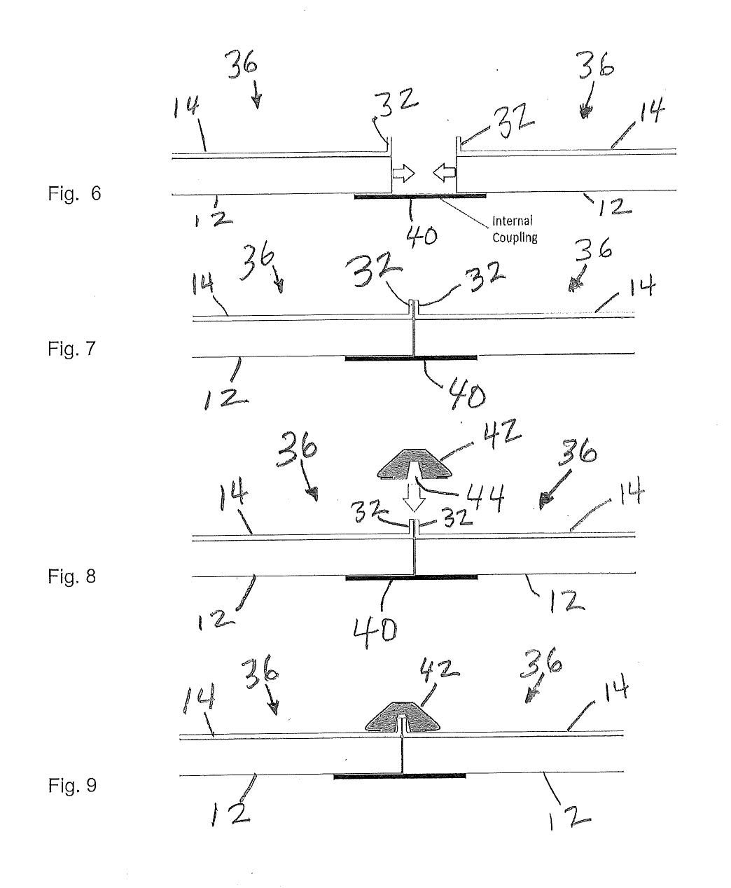

In FIGS. 6 through 9, steps in a method for connecting two flanged duct section pre-forms 36, and structures associated therewith are illustrated. A circumferentially shaped coupling 40 is positioned, relative to the flanged duct section pre-forms 36, so that it spans the seam between the panels 12 of the two flanged duct section pre-forms 36. The internal coupling 40 has an outer diameter substantially equal to the internal diameter of the cylindrically shaped foam panels 12 in the two adjacent flanged duct section preforms 36. The flanged duct section pre-forms are pushed together until the flanges 32 are adjacent to each other.

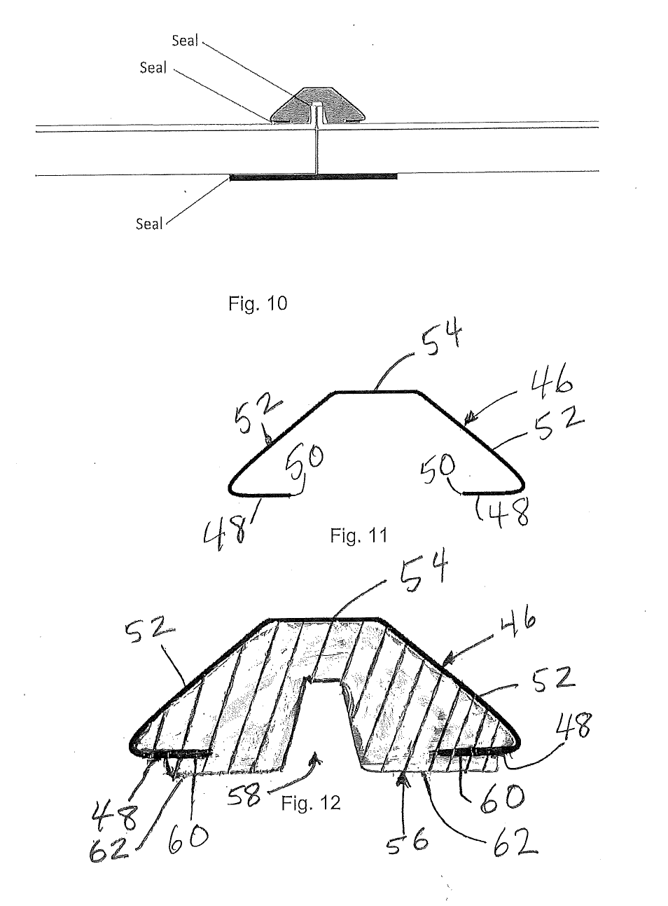

As shown in FIG. 8, a belly band 42 having a groove indicated at 44 is positioned over the two flanges 32. The belly band 42 has an internal gasket in which the groove 44 is formed. The belly band 42 is described in more detail below with reference to FIGS. 11 to 13. The belly band 42 is snugged up against the sheets 14 and both of the flanges are captured within the groove 44, as shown in FIG. 9. Thus, as shown in FIG. 10, the belly band 42 creates seals between the flanges 32 and between the exterior surfaces of the sheets 14 adjacent to the flanges 32. The internal coupling 40 seals the interior seam between the foam panels 12.

Details of a preferred embodiment of the belly band 42 are shown in FIGS. 11 through 13. The belly band comprises a gasket support band 46 shown in cross section in FIG. 11. The band 46 can be a single piece formed, for example, by roll forming sheet metal. The band 46 is generally U-shaped in cross-section and may be roll formed flat. The band 46 comprises two inwardly extending legs 48, each having a first free end 50 and a second end connected to the first ends of two side walls 50. A lateral wall 54 is connected to and connects second ends of the side walls 50.

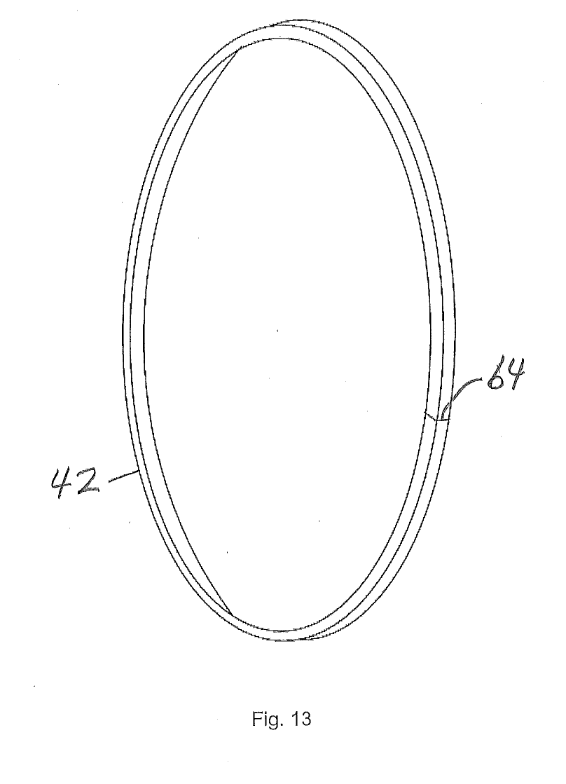

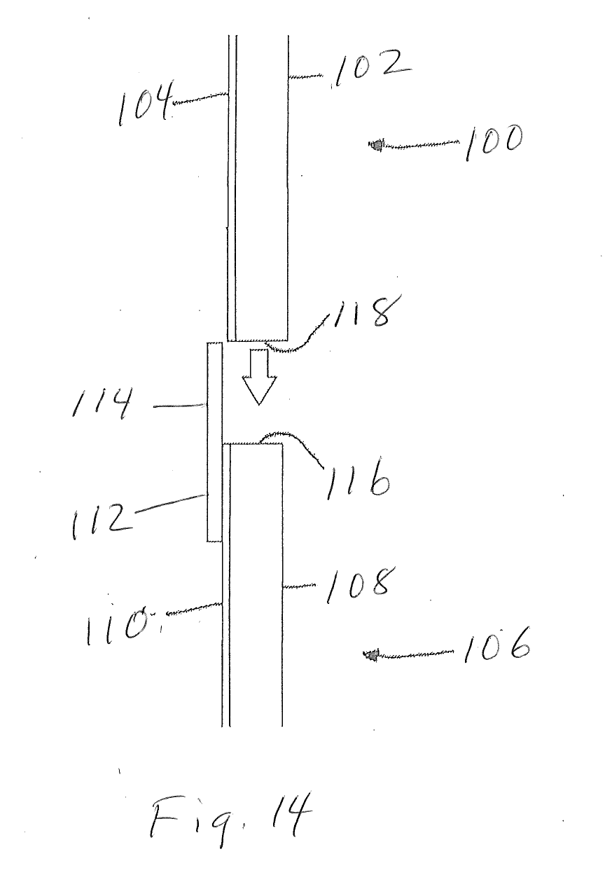

A generally U-shaped gasket 56 is support in the gasket support band 46. The gasket 56 may be extruded from elastomeric material and inserted into the support band 52. The gasket 56 has a central groove indicated at 58 for receiving adjacent radially extending flanges 32, as shown in FIGS. 9 and 10. The gasket 56 further comprises two side grooves 60 for receiving the inwardly extending legs 48 of the gasket support band 46. The gasket 56 comprises two sealing flanges 62 on each side of the gasket, adjacent to the side grooves 60. The gasket support band 46 with the gasket 56 therein is rolled to a circular shape as indicated in FIG. 13 which is sized according to the following considerations.

When the belly band 42 is applied to adjacent flanged duct section pre-forms 36, as shown in FIGS. 9 and 10, the sealing flanges 62 engage and seal against the outer surfaces of the sheets 14 in the pre-forms 36. The depth and width of the groove 58 are sized so that they engage the radially extending flanges 32. The groove 58 is narrower at the bottom than it is at the mouth so that, as it is drawn tight around the flanges 32 of adjacent flanged duct section pre-forms 36, it exerts a force against the flanges 32 pushing them towards each other. Further, the peripheries of the flanges 32 engage the gasket material at the bottom of the groove 58.

The ends of the rolled belly band 42 may be moved apart so that the belly band 42 may be positioned around one of the flanged duct section pre-form, and then brought back together so that the belly band 42 has a hoop shape, as shown in FIG. 13, with a slip joint seam indicted at 64. The belly band 42 can be opened at the seam 64 and positioned over the flanges 32 so that they are received in the groove 58. Then, the ends of the belly band 42 are drawn together to form the seam 64. Couplers (not shown) may be provided on the free ends of the belly band 42 for drawing the free ends together and tightening the belly band 42 around the flanges 32 and the adjacent portions of the flanged duct section pre-forms. The couplers may be threaded couplers.

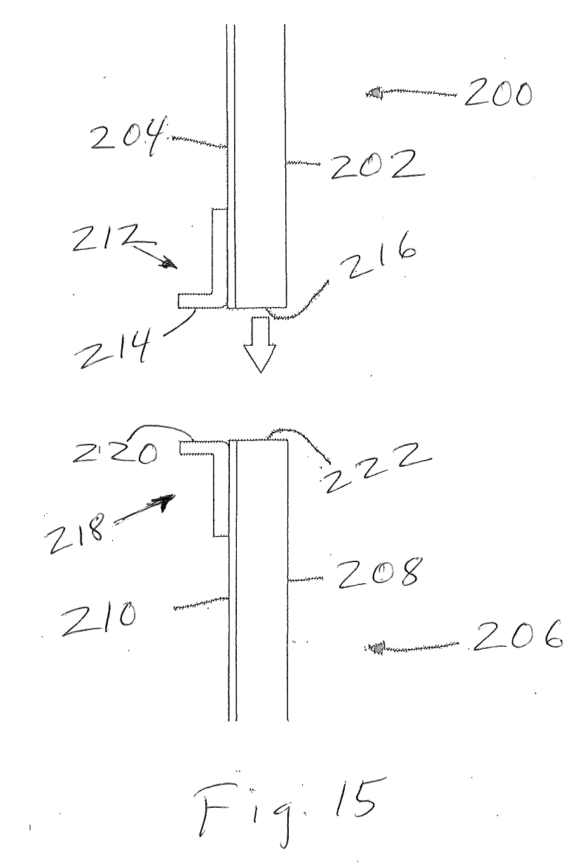

Referring now to FIG. 14, a cross section through a longitudinally extending wall of a duct section, another embodiment of a duct section connector is illustrated. The duct sections may be made generally as described above (before the flanges 32 are formed). In FIG. 14, the end portion of a first duct section is indicated at 100. The first duct section 100 comprises a foam sheet 102 and a thermoplastic sheet 104 cohesively bonded together. The thermoplastic sheet 104 would be on the outside of the duct and the foam sheet 102 would be on the inside of the duct. The end portion of a second duct section is indicated at 106. The second duct section 106 comprises a foam sheet 108 and a thermoplastic sheet 110 cohesively bonded together. The thermoplastic sheet 110 would be on the outside of the duct and the foam sheet 108 would be on the inside of the duct.

A circumferentially extending flange 112 extends around the thermoplastic sheet 110. The flange 112 may be made from a strip of thermoplastic material and, in the finished duct, the flange 112 would extend circumferentially all the way around the end of the duct sections 100 and 106. In a preferred method, the strip 112 has a length which is slightly less than the outside diameter of the duct, i.e., the outside surface of the thermoplastic sheet. The strip 112 is then heated to soften it and the strip is manipulated by wrapping it around the outside of the thermoplastic sheet 110 so that it has a hoop shape. In case the strip 112 has a length that is less than the outer circumference of the thermoplastic sheet 110, the strip 112 can be manipulated, while it is soft, to have a length equal to the outer circumference of the thermoplastic sheet. A portion of the strip 112 is then securely fastened to the exterior of the thermoplastic sheet 110, as by adhesive, sonic welding, heat, and/or pressure. A portion 114 of the strip 112 extends beyond the end 116 of the duct section 106 and forms a sleeve, of sorts, into which the end 118 of duct section 100 may be received. The end 118 is inserted, in the direction of the arrow, into the sleeve formed by the strip 112 until the end 118 abuts the end 116 of the duct section 106, and the portion 114 of the sleeve formed by the strip 112 is securely bonded to the thermoplastic sheet 104 where the two overlap, thereby connecting the duct sections 100 and 106.

In FIG. 15, the end of a first duct section is indicated at 200. The first duct section 200 comprises a foam sheet 202 and a thermoplastic sheet 204 cohesively bonded together. The thermoplastic sheet 204 would be on the outside of the duct and the foam sheet 202 would be on the inside of the duct. The end portion of a second duct section is indicated at 206. The second duct section 206 comprises a foam sheet 208 and a thermoplastic sheet 210 cohesively bonded together. The thermoplastic sheet 210 would be on the outside of the duct and the foam sheet 208 would be on the inside of the duct.

A circumferentially and longitudinally extending angled flange 212 extends around the thermoplastic sheet 204. The angled flange 212 includes a rib 214 which extends radially outwardly from the thermoplastic sheet 204. The flange 212 may be made from an angled strip of thermoplastic material and, in the finished duct, the flange 212 would extend circumferentially all the way around the end of the duct section 200. In a preferred method, the strip 212 has a length which is slightly less than the outside diameter of the duct, i.e., less than the length of the outside surface of the thermoplastic sheet 204. The strip 212 is then heated to soften it and the strip 212 is manipulated by wrapping it around the outside of the thermoplastic sheet 204 so that it has a hoop shape. In case the strip 212 has a length that is less than the outer circumference of the thermoplastic sheet 204, the strip 212 can be manipulated, while it is soft, to have a length equal to the outer circumference of the thermoplastic sheet 204. A portion of the strip 212 is then securely fastened to the exterior of the thermoplastic sheet 204 as by adhesive, sonic welding, heat, and/or pressure. The radially extending rib 214 is flush with the end 216 of the duct section 200.

A circumferentially and longitudinally extending angled flange 218 extends around the thermoplastic sheet 210. The angled flange 218 includes a rib 220 which extends radially outwardly from the thermoplastic sheet 210. The flange 218 may be made from a strip of thermoplastic material and, in the finished duct, the flange 218 would extend circumferentially all the way around the end of the duct section 206. In a preferred method, the strip 218 has a length which is slightly less than the outside diameter of the duct, i.e., less than the outside surface of the thermoplastic sheet 210. The strip 218 is then heated to soften it and the strip 218 is manipulated by wrapping it around the outside of the thermoplastic sheet 210 so that it has a hoop shape. In case the strip 218 has a length that is less than the outer circumference of the thermoplastic sheet 210, the strip 218 can be manipulated, while it is soft, to have a length equal to the outer circumference of the thermoplastic sheet 204. The strip 218 is cooled to retain its hoop shape and final length. A portion of the strip 218 is then securely fastened to the exterior of the thermoplastic sheet 210 as by adhesive, sonic welding, heat, and/or pressure. The radially extending rib 220 is flush with the end 222 of the duct section 206.

The duct sections 200 and 206 are then connected in the manner described above by using a belly band such as the belly band described above with reference to FIGS. 1 through 13.

In the embodiments described above with reference to FIGS. 14 and 15, the strips of thermoplastic material 112, 212, and 218 will have a given thickness and so will the thermoplastic sheets 104, 110, 204, and 210. It is preferred that the thickness of the strips of thermoplastic material 112, 212, and 218 will be greater than the thickness of the corresponding thermoplastic sheets 104, 110, 204, and 210. It is preferred that the thickness of the strips of thermoplastic material 112, 212, and 218 will be at least twice the thickness of the corresponding thermoplastic sheets 104, 110, 204, and 210. It is more preferred that the thickness of the strips of thermoplastic material 112, 212, and 218 will be at least three times the thickness of the corresponding thermoplastic sheets 104, 110, 204, and 210.

In a further embodiment of the invention, the thermoplastic sheet may be replaced with flanged sheet metal to provide a sheet metal sheath for the duct pre-forms. In this case, the flanged sheet metal may be free from the foam panel, i.e., not bonded thereto. Or, the flanged sheet metal sheet may be bonded to the foam panel either before or after it is rolled into a cylindrical shape. Flanged sheet metal duct section pre-forms may be connected using a belly band of the type described above.

In a further embodiment, a sheet metal liner may be provided in a duct section pre-form. The liner may be positioned on the foam panel before it is rolled into a cylindrical shape, and rolled up with the foam panel. Alternatively, the sheet metal liner may be inserted into the rolled up duct section pre-form. Such pre-form may include a thermoplastic sheet exterior sheath, a sheet metal exterior sheath, or no exterior sheath. In a duct section pre-form having a sheet metal liner, the foam insulation panel outside of the sheet metal liner may have any desired composition. The foam panel can be a phenolic foam, as described above. Alternatively, the foam panel may be composed of other materials including, but not limited to, polystyrene foam, polyisocyanate foam, and polyethylene foam.

I claim:

1. A method for connecting a first duct section to a second duct section where the duct sections comprise a laminate formed of an outer layer of a thermoplastic sheet and an inner layer of a foam sheet, said method comprising the steps of
providing a strip of thermoplastic material,
heating the strip of thermoplastic material to soften it,
wrapping a first portion of the heated strip around the end of the first duct section so that a second portion of the strip extends beyond the end of the first duct section,
securely fastening the first portion of the heated strip around the end of the first duct section,
inserting the end of the second duct section into the sleeve, and
securely fastening the sleeve portion of the heated strip around the end of the second duct section.

2. The method claimed in claim 1 wherein the length of the strip, before heating, is less than the outer circumference of the first and second duct sections and wherein, when the strip is heated, it is stretched until it has a length equal to the outer circumference of the first and second duct sections and wherein the shape and length of strip is held until the thermoplastic strip cools.
